(19) United States
(12) Patent Application Publication
(10) Pub. No.: US 2009/0316526 A1
(43) Pub. Date: Dec. 24, 2009

(54) SYSTEM OF SELF-PROPELLED SEISMIC STREAMERS

(76) Inventor: Georges Grall, Biot (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 12/527,836

(22) PCT Filed: Feb. 8, 2008
(86) PCT No.: PCT/FR08/00155

§ 371 Date: Aug. 19, 2009

(30) Foreign Application Priority Data
Feb. 19, 2007 (FR) 0701165
Mar. 29, 2007 (FR) 0702300

(51) Int. Cl. G01V 1/38

(52) U.S. Cl. 367/20

(57) ABSTRACT

Systems are described which make it possible to carry out a 3D seismic survey from the surface of the sea. The systems include individual standalone assemblies each including an electrically propelled fish which tows each seismic streamer the other end of which is positioned by a tail fish. These assemblies are connected, electrically and mechanically, via an electro-towing cable to the streamlined cables for towing the diverging paravanes.

### BACKGROUND OF THE INVENTION

1. Field of the Invention

The present invention relates to the systems that make it possible to carry out a “3D” submarine seismic survey for the purpose of detecting the zones of sediments containing oil.

2. Description of the Relevant Art

It is known practice to carry out marine seismic surveying with the aid of a boat specially designed for this type of mission. This boat, called a seismic survey boat, tows a set of very long (6 km) and small-diameter (70 mm) acoustic antennae containing hydrophones; they are terminated by tail buoys. The depth of the antennae is limited to approximately 7 m.

This assembly may include up to 16 antennae called seismic streamers. The maximum distance between streamers is ensured by a system of diverging paravanes which requires a towing force of 150 to 200 tons for a towing speed of 4 to 5 knots. It is the streamers closest to the diverging paravanes which limit the aperture of the V formed by the seismic survey boat and these diverging paravanes; specifically the drag of a streamer reaches 1 to 1.5 tons. Currently it seems difficult to exceed 16 streamers and therefore a swept width of 1500 m with the conventional solutions.

### SUMMARY OF THE INVENTION

To overcome the disadvantages of prior systems, it is desirable to:

Provide a system making it possible to greatly reduce, and even to completely remove the towing forces due to the drag of the streamers on their attachment points to the cable for towing the diverging paravanes, so that the latter do not have to compensate for their own drag and that of their cable, thereby making it possible to very significantly increase the width of sweep and increase the number of streamers up to 24.

Provide a system linked to the towing cable which makes it possible simultaneously to reduce the drag force of the cable, to contain the electric power supply cables and the electric or optical cables sending back the seismic signals from the streamers to the seismic survey boat.

Provide a system that makes it possible to compensate for the weight in the water of the towing cable in order to reduce the lift of the diverging paravanes and therefore their drag.

Provide a system that also makes it possible to compensate for the drag of the diverging paravanes situated at the end of towing cables.

Provide a system which makes it possible to sail at least 24 streamers at a depth that is adjustable from 0 to 30 m in order to avoid the disturbance induced by the swell, if necessary.

Provide a system that makes it possible to control the geographic position of the tail of the streamers and keep them in a straight line.

In order to overcome the disadvantages and limitations of the existing systems, a device is proposed according to the appended claims, mainly characterized in that each streamer is towed by a submarine vehicle, called a towing fish with electric propulsion, and that this fish is connected and supplied by an electro-towing cable at an attachment point situated on the cable for towing the diverging paravane.

According to another feature, the towing fish has diving rudders allowing it to adjust its depth to the setpoint value.

According to another feature, the towing fish has directional rudders allowing it to sail parallel to the trajectory of the seismic survey boat, thanks, for example, to an acoustic location system which provides it with the bearing of its attachment point, whose position is known.

According to another feature, the towing fish applies a slight mechanical tension (approximately 500 Newtons) to the attachment point of the electro-towing cable.

According to another feature, the speed of the towing fish is controlled thanks to measuring the mechanical tension applied to the electro-towing cable, which must remain constant.

According to another feature, a damping device at the cable entry, for example on the yoke of the towing fish makes it possible to eliminate the vibrations and residual jolts coming from the cable for towing the diverging paravanes.

According to another feature, the electric power (50 to 70 KW) for each fish is transmitted thanks to a high-voltage electric cable (for example 3000 volts) leaving the seismic survey boat, running along the cable for towing the diverging paravane to the attachment point where it is connected to the electro-towing cable.

According to another feature, this electric connection also allows the transmission of seismic data originating from the streamer to the seismic survey boat, and the instructions from the boat to the towing fish, the streamer and the tail fish.

According to another feature, streamlining elements are attached all along the towing cable and their shape makes it possible to reduce by a considerable factor the hydrodynamic coefficient of the towing cable.

According to another feature, these streamlining elements include electric power supply conductors for the towing fish, and the electric or optical cables carrying the seismic signals and the instructions necessary to the towing fish, streamers and tail fish.

According to another feature, these streamlining elements are freely articulated about the towing cable in order to align themselves collinearly with the relative flow of the water.

According to another feature, these streamlining elements are mechanically and electrically connected to branching devices making it possible to supply each towing fish with power and to carry the signals from each streamer and to mechanically secure the assembly all along the towing cable.

According to another feature, these streamlining elements fitted with their electric conductors have a density of one.

According to another feature, these streamlining elements have a great mechanical resistance to towing thanks to integrated cables that are made of metal or Kevlar or any other material making it possible to withstand the slipping forces along the towing cable, particularly if the towing fish fail or if there are no towing fish.

According to another feature, the longitudinal mechanical strength and the section of the streamlining elements can reduce in line with their distance from the seismic survey boat because the first must, on the one hand, withstand the forces induced by all of the streamers and, on the other hand, allow the passage of the electric conductors for all the towing fish and all the streamers, the last streamlining element having to supply only one towing fish and only one streamer and to withstand the forces induced by one towing fish and its streamer.

According to another feature, the branching devices are located at distances along the towing cable that make it possible to choose the pitch between streamers, for example, 50, 100, 150, 200 meters.

According to another feature, floats are placed along the towing cable and their buoyancy compensates for the weight in the water of the towing cable.

According to another feature, these floats have a slightly negative lift when the assembly moves at the operating speed of 4 knots, in order to submerge and avoid the surface movements.

According to another feature, the diverging paravanes may be fitted with propulsion or towing devices in order to reduce to the minimum their drag in the water and thereby make it possible, at a given stand-off behind the boat, to increase the maximum lateral stand-off.

According to another feature, the tail fish, the role of which is to tension the seismic streamer in order to keep it in a straight line and horizontal, has a hydrodynamic brake with a controllable effect in order to apply a constant mechanical tension to the tail of the streamer when the speed relative to the water varies.

According to another feature, the tail fish has a depthwise movement capability of 0 to 30 m.

According to another feature, the tail fish deploys a surface buoy fitted with a radioelectric positioning receiver, for example the GPS system, in order to ascertain the position of the tail.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 represents a top view of half of the system, in which are shown 12 streamers, 12 towing fish, 12 tail fish and the detail of a float to compensate for the weight of the cable for towing the diverging paravane, the whole assembly being towed by the seismic survey boat.

FIG. 2 represents one of the possible embodiments of the towing fish.

FIG. 3 represents a possible embodiment of the tail fish.

FIG. 4 represents the rigging of the tail fish having deployed its location buoy.

FIG. 5 represents a possible embodiment of the branching box.

FIG. 6 represents another possible embodiment of the branching box.

FIG. 7 represents in perspective an exploded view of a possible embodiment of the streamlining element mounted on the cable for towing the diverging paravane.

FIG. 8 represents the diverging paravane fitted with an electric propulsion system.

FIG. 9 represents an embodiment of a winch for deploying and recovering the total system with the type of rigging described by FIG. 1.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

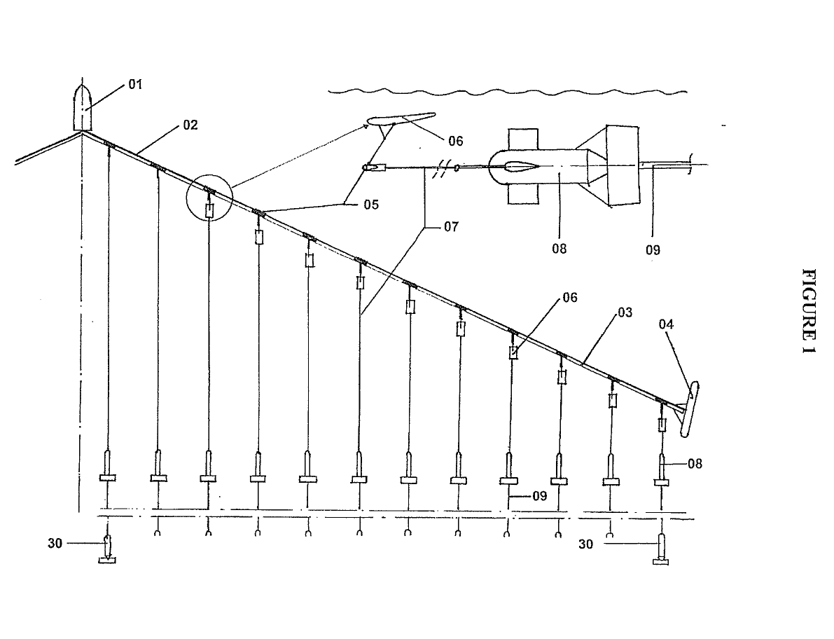

The seismic survey system shown in FIG. 1 includes, as an example, the seismic survey boat (01), 2×12 seismic streamers (09) towed by 2×12 fish (08) with electric propulsion, which are connected to the towing cable (02) of the diverging paravane (04) by cables (07). The 2×12 self-propelled streamers are terminated by 2×12 tail fish (30). The weight of the cable (02) is compensated for by the floats (06) located at each join where the branching boxes (05) are situated, these floats in the form of an inverted wing sink during operational submersion to approximately 7 m beneath the surface when the assembly moves, thanks to the negative lift of the float.

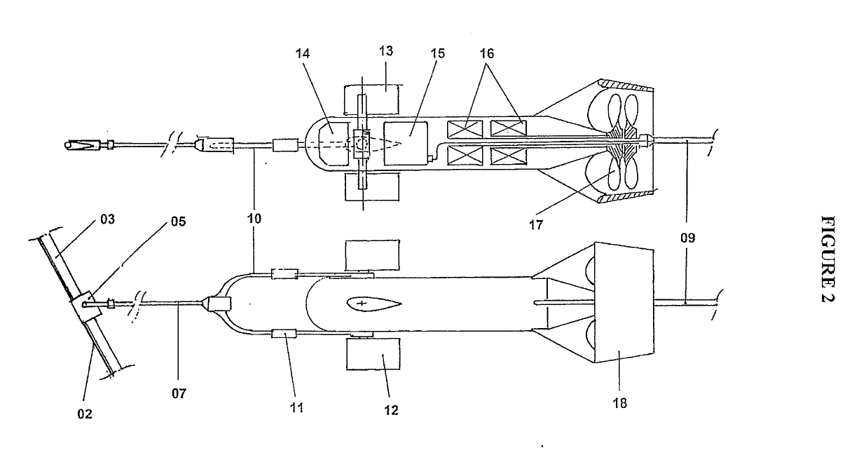

FIG. 2 represents an exemplary embodiment of a towing fish which is propelled by two contra-rotating propellers (17) that are streamlined (18) in order to increase their efficiency. These propellers are driven by two electric motors (16), in the axis of which the signals originating from the streamer (09) travel in order to be carried to the seismic survey boat (01) via the cables (07) and (02). The high power supply voltages are reduced by the transformer (14) before being applied to the motors, via power electronics (15) which make it possible to control the speed of movement of the fish under the control of a tensiometer (11) installed, for example, on the towing yoke (10), in order to maintain a constant and weak mechanical tension in the electro-towing cable (07). Depth control is ensured by the depth rudders (12) under the control of a depth sensor. Heading control is ensured by the directional rudders (13) based on the attachment-point bearing information delivered by an acoustic transponder mounted on the nose of the fish the emitted pulse of which is reflected on the float (06). The length D of the electro-towing cable (07) is designed to allow a depth adjustment of 0 to 30 m, while limiting the vertical force on the depth rudders, namely from 150 to 200 m. This cable has a mechanical strength allowing it to tow the fish and streamer assembly when the latter has failed.

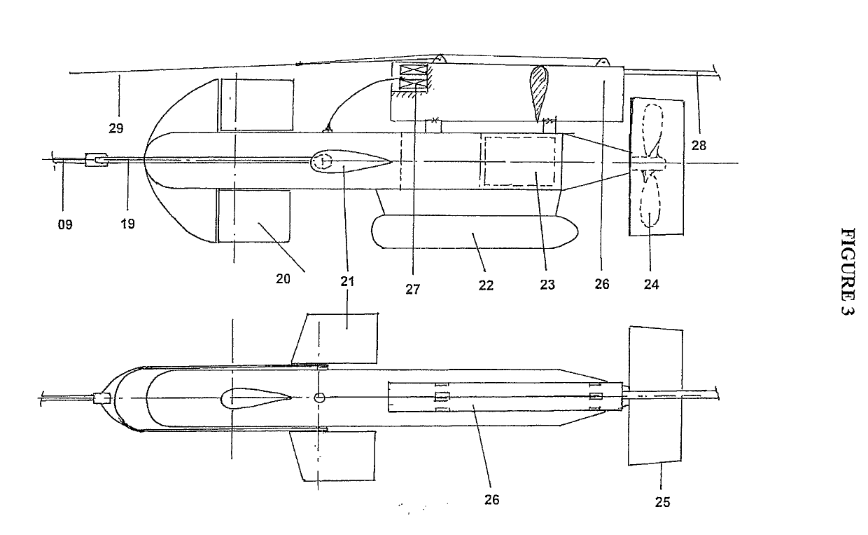

FIG. 3 represents an embodiment of the tail fish (30) whose role is to position the tail of the streamer and to keep it in a straight line and horizontal, at the setpoint depth and at a planned distance from the adjacent streamers. The tail fish consists of a submersible profiled body fitted with depth rudders (21), and heading rudders (20).

A device for regulating the mechanical tension of the streamer (09), in the case of a variation in speed relative to the water, is used. It includes a brake propeller (24) rotated by the speed of movement; this propeller drives an electric generator (23) which outputs a variable resistive charge. The value of this charge is controlled by a closed-loop control which compares, with the aid of a tensiometer, the real value applied to the tail of the streamer with a setpoint value (approximately 1000 Newtons). This generatrix also makes it possible to recharge the batteries situated in the keel (22) in order to supply the electronics of the fish. A yoke (19) absorbs the traction forces and provides the electric connection between the fish and the streamer. In order to locate the tail of the streamer, the fish deploys a surface float (26) which is fitted with a mast (28) carrying a radiolocation antenna (33), for example a GPS receiver.

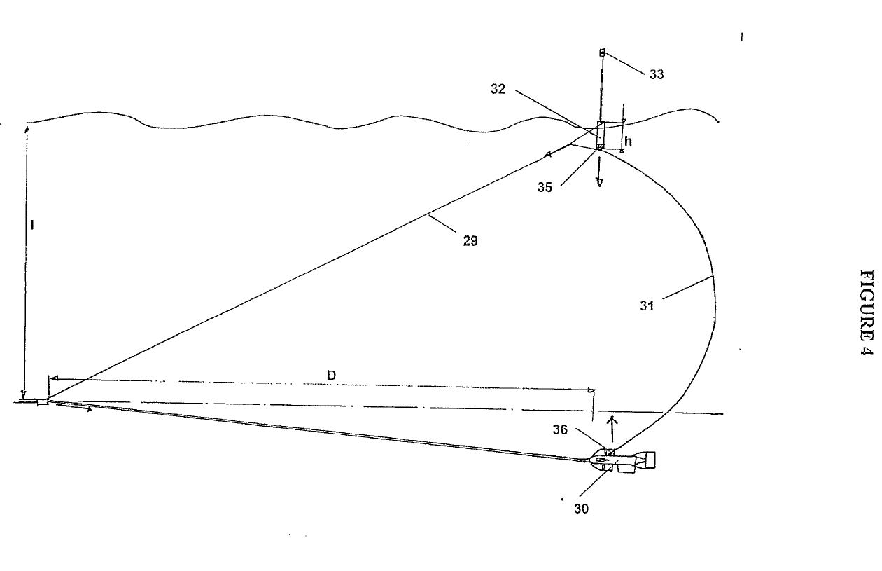

FIG. 4 represents the tail fish (30) at operational depth with its location buoy (26) deployed. The buoy is kept vertical relative to the tail fish thanks to a rope (29) attached to the streamer at a distance D which is great given the depth of the fish. The buoy sails vertically thanks to the system of shrouds attached on the one hand to the rope and on the other hand to its body (32). The geographic positional information delivered by the satellite receiver is transmitted to the streamer via the connecting cable (31) which, before deployment, is stowed in the form of a coil (27).

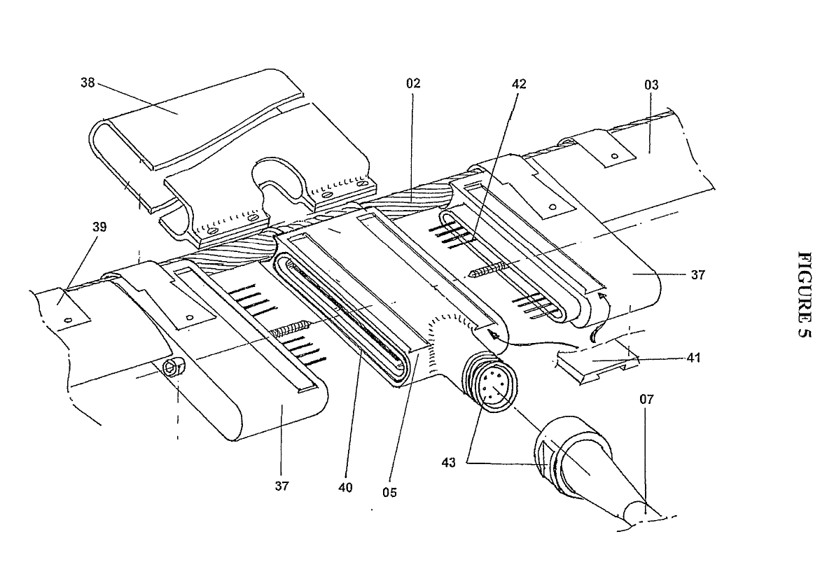

FIG. 5 represents an exemplary embodiment of a branching device (05) which consists of 2 oblong sealed electric connectors and another sealed connector (43) allowing the electrical and mechanical connection of the leash (07) of the towing fish.

Connected to this branching device are the connectors (37) situated at the end of the streamlining elements. A cover (38) makes it possible to removably connect the branching device (05) to the towing cable (02) allowing it free rotational movement. The total thickness of the branching device (05) is equal to that of the streamlining elements (03) so that they can be wound in a single layer on the drum of the winch that has to wind in the streamlined cable. For the mechanical connection, use is made, for example, of four dovetailed tongues (41) which slide in grooves machined into the body of the connectors once the electrical connection has been made. The electrical power and high-voltage connections (42) are placed in line in order, on the one hand, to fit into the thickness that is necessary for winding to be possible in a single layer onto the drum of the storage winch and, on the other hand, in order to keep the high potential difference (3000 V) conductors as far away as possible. The seal is provided by two O-rings (40).

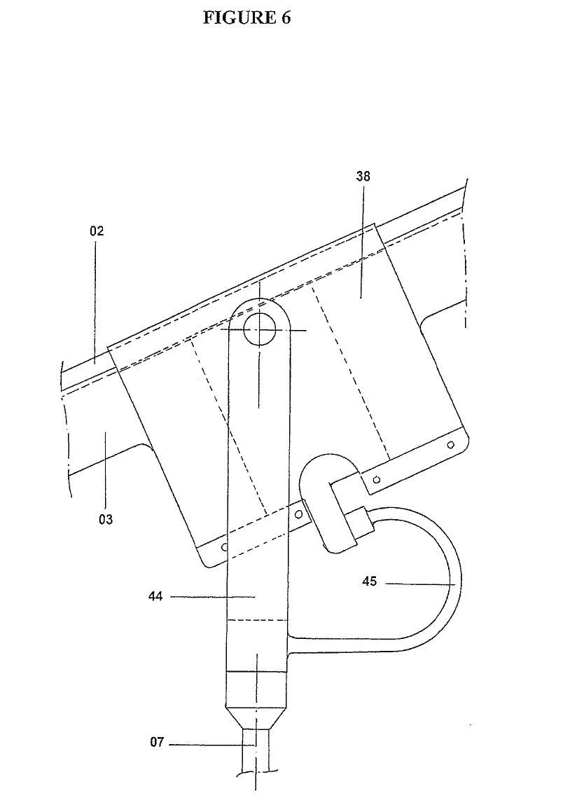

FIG. 6 represents a variant of the branching device, in which the mechanical and electrical connections with the leash (07) of the fish are separate. The mechanical connection is provided by a removable articulated yoke (44). The electrical connection is provided by a sealed hose (45) terminated by a connector. These types of connections make it possible to adapt to the geometric variations between the towing cable (02) and the leash (07) and thus removes the bracing effects of the cover (38) on the cable (02).

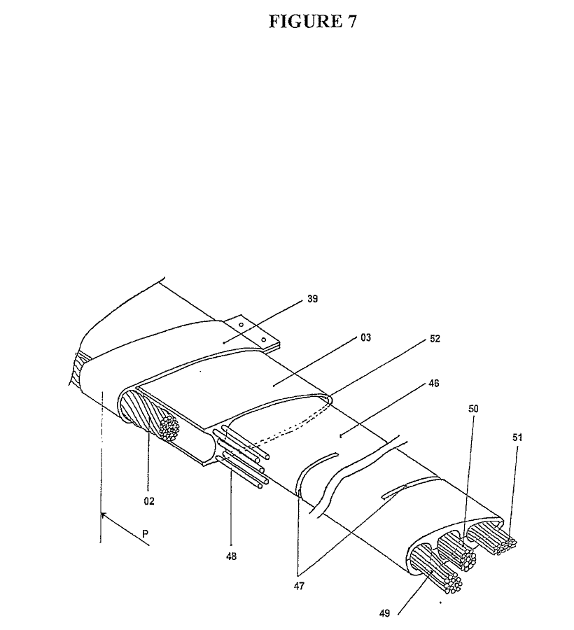

FIG. 7 represents, by way of example, the structure of the profiled streamlined element (03) mounted on the cable (02), the outer casing (52) made of flexible and strong material such as for example polyurethane, is filled with oil and a low-density foam core (46) making it possible to balance in the water the weight and the moments of the electric power conductors (49; 50) and of the electric conductors of low-level signals (51). The core (46) is notched at regular intervals (47) in order to allow unstressed winding. A fastening clip (39) situated at approximately every meter makes it possible to attach or uncouple from the towing cable (02) the various streamlining elements. A network of wires, for example made of Kevlar (48), is included in the streamlining element giving it a mechanical strength required by operational use. The ends of these wires are attached to the connectors (37).

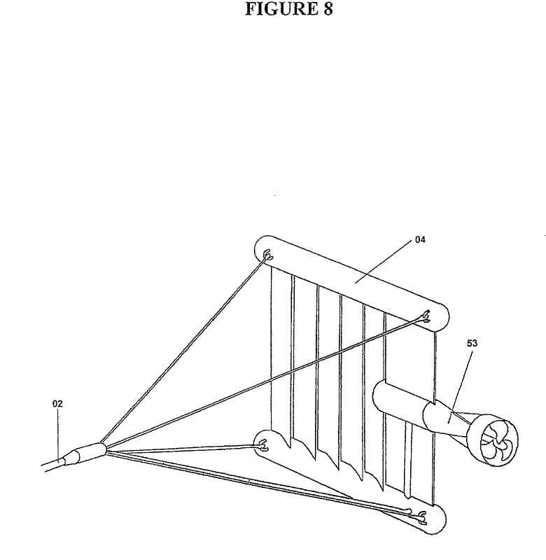

FIG. 8 shows a possible embodiment of an “active” diverging paravane (04) which has a propulsion system (53) which may or may not be incorporated; in a variant, it is possible to use several propulsion systems. The propulsion system applies a thrust parallel to the trajectory of the boat the value of which makes it possible to compensate as little as possible for the drag specific to the diverging paravane, so as either to reduce the rear stand-off relative to the boat, or, at a given stand-off, to increase the number of seismic streamers. The propulsion system is supplied via an electric line of the same type as those used for the towing fish.

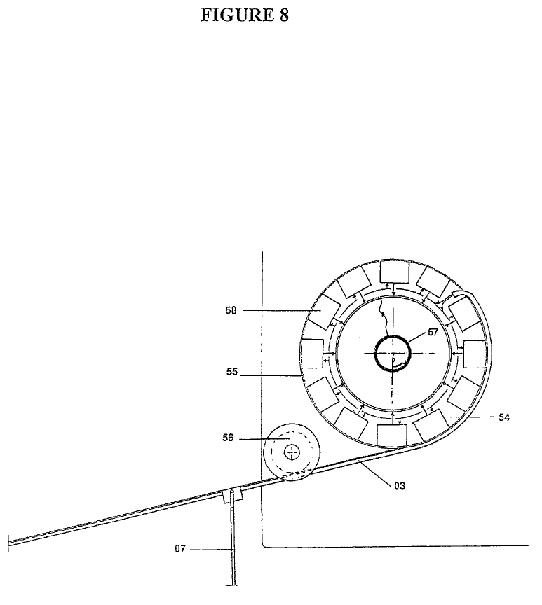

FIG. 9 represents a possible embodiment of a winch for deploying and recovering the total system with the type of rigging described by FIG. 1. The particular feature is to produce a winch (54) with a large drum (55) (8 m in diameter for example) in order to wind up the whole cable (2500 m for example) with its streamlining elements in a single layer; a cable transfer system (56) is used to ensure the correct positioning of the streamlining elements (03), namely perpendicular to the surface of the drum. The power for the towing fish is sent to the conductors situated in the streamlining elements via a rotating seal (57). The high supply voltages of the towing fish are generated by transformers (58) attached to the drum of the winch. The rotating seal (57) makes it possible to deliver to the transformers the power necessary to the fish in order to prevent a large number of rotating seals transferring the high voltages. The seismic signals and the instructions pass through a specific rotating seal or, in a variant, may be transmitted via a very short-range radio system.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system for “3D” submarine seismic surveying operating close to the surface comprising several streamers in parallel which allow the reception of seismic signals, wherein deployed laterally on each side of the boat is a set of electric power conductors connected to the cables of the diverging paravanes supplying a set of towing fish to which are coupled streamers of a known kind, at the end of which there is a tail fish, in order to decouple the mechanical resistance of the cable connecting the boat to the diverging paravanes from the drag force of the set of streamers.

2. The system as claimed in claim 1, wherein the towing fish is fitted with electric motorization which drives two counter-rotating propellers and the fish can be controlled in depth and in heading thanks to the depth rudders and directional rudders.

3. The system as claimed in claim 2, wherein the heading navigation of the towing fish is determined by the information from the bearing of the attachment point thanks to an acoustic device mounted on the nose of the fish and on the other hand a reflector situated on or close to the attachment point.

4. The system as claimed in claim 2, further comprising a sensor, mounted on the yoke, that measures the misalignment of the leash with the axis of the fish in order to correct the heading of the fish thanks to the rudders.

5. The system as claimed in claim 1, wherein the thrust of the propellers of the fish is slaved to the value of the mechanical tension applied to the yoke measured by the tensiometer, in order to keep this tension at a low value.

6. The system as claimed in claim 1, wherein the towing fish can modify and regulate its depth between 0 and 30 meters, thanks to the depth rudders controlled by the value measured by a depth sensor.

7. The system as claimed in claim 1, wherein the submersible tail fish in operation ensures a constant mechanical tension on the tail of the streamer thanks to a hydrodynamic brake performed by a propeller driving an electric generator charged by a rheostat the value of which is controlled by the measurement of the mechanical tension applied to the tail of the streamer.

8. The system as claimed in claim 1, wherein the tail fish can deploy a surface float fitted with a radiolocation antenna and in that the surface float is towed via a rope the length of which is great given the value of the maximum depth, and in that the geographic position information is transmitted from the float to the tail fish via a cable the length of which is always greater than the depth.

9. The system as claimed in claim 1, wherein the system is adapted to the towing of the seismic streamers, directly, via towing fish, and wherein the towing cable of the diverging paravanes is fitted with a set of sections forming a profiled streamlining element, and in that these sections are connected together by branching devices, to which are connected, either directly, the seismic streamer connectors in the case of passive towing, or the leashes of the towing fish in the case of active towing.

10. The system as claimed in claim 1, wherein the profiled streamlining elements comprise the electric conductors for supplying the towing fish and the electric or fiber-optic conductors for the seismic signals and the wires defining their longitudinal mechanical resistance.

11. The system as claimed in claim 1, wherein the streamlining elements are hollow and made of a flexible, strong material and in that they are filled with oil and contain a foam core that is of lower density than the water and has strong electric insulation, which makes it possible to obtain a density of one for the fitted streamlining.

12. The system as claimed in claim 1, wherein the streamlining elements are terminated by connectors which absorb the mechanical forces and provide electrical or optical connections and that these elements have, if necessary, a section and a mechanical strength dependent on their position along the towing cable.

13. The system as claimed in claim 1, wherein the streamlining elements are attached removably to the cable by clips and in that the streamlining elements rotate freely about the towing cable.

14. The system as claimed in claim 1, wherein the branching devices absorb the mechanical forces between two adjacent streamlining elements via the tongues, that the seal is provided by the O-rings and that the connection that is freely rotatable about the cable is provided by a cover.

15. The system as claimed in claim 1, wherein the branching devices are mechanically connected to the leash of the fish via an articulated yoke and electrically connected via a hose containing the power and signal conductors for the fish and the streamers.

16. The system as claimed in claim 1, wherein the floats are attached to the branching devices along the streamlined cable and that these floats are removable so as to be easily installed when the towing cable is unwound and uninstalled when it is rewound, and in that these floats provide a slight positive buoyancy of the streamlined cable but are submerged in operation, thanks to a slightly negative lift which exactly compensates for their positive buoyancy.

17. The system as claimed in claim 1, further comprising a propulsion system that drives the diverging paravane by applying a thrust parallel to the trajectory of the seismic survey boat so as to reduce to the minimum the drag of the diverging paravane.

18. The system as claimed in claim 1, wherein a winch with a drum having a diameter such that it can wind up the streamlined cable in a single layer, and that a cable transfer device makes it possible to position the streamlined electric cable on the edge, that is to say perpendicularly to the generatrix of the drum.

19. The system as claimed in claim 1, wherein the winch is fitted with a rotating seal making it possible to transmit, during the rotation of the drum, the necessary power to the assembly of the towing fish and the diverging paravane propulsion system, and that the high-voltage transformers are attached to the drum and rotate with it.
